(19) United States
(12) Patent Application Publication
(10) Pub. No.: US 2009/0063970 A1
(43) Pub. Date: Mar. 5, 2009

(54) SYSTEM, METHOD AND PROGRAM PRODUCT FOR EXCHANGING INFORMATION BETWEEN A VIRTUAL ENVIRONMENT TO A NON-VIRTUAL ENVIRONMENT

(75) Inventors: Daphna STEINMETZ, Ramat-Gan (IL); Idan Cohen, Herzeliya (IL)

Correspondence Address: SUGHRUE MION, PLLC, 2100 PENNSYLVANIA AVENUE, N.W., SUITE 800, WASHINGTON, DC, 20037, US

(73) Assignee: COMVERSE LTD., Tel Aviv (IL)

(21) Appl. No.: 11/848,192

(22) Filed: Aug. 30, 2007

(51) Int. Cl. G06F 3/048

(52) U.S. Cl. 715/706

(57) ABSTRACT

Provided is a method for exchanging information, the method including: receiving content destined to a virtual representation of a recipient; sending the content to a recipient communication device that is being utilized by the recipient for non-virtual communication by utilizing an association between a virtual representation of the recipient and an identity of the recipient while concealing the association. Also provided is a method for participating in a virtual environment, the method including: receiving instructions from a limited device not capable of interfacing with the virtual environment; converting the instructions to a virtual environment-compliant format; sending the converted instructions to a virtual environment computer; receiving content from the virtual environment; converting the content to a limited device-compliant content; and sending the converted content to the limited device.

### FIELD OF THE INVENTION

The present invention relates to a method, a system and a program product for exchanging information between a virtual environment and a non-virtual environment.

### BACKGROUND OF THE INVENTION

The importance of virtual environments (such as but not limited to virtual worlds) has dramatically increased during the last couple of years. Tens of millions of people prefer to participate in virtual environments and even enjoy a virtual life.

The virtual worlds are global, beyond geographies, nationalities, religions and other constrains, and people find more and more interest in spending time and emotional energy in developing an alternative reality for themselves, including relations with other individuals.

People who participate in virtual worlds want to stay intact with what's happening in the virtual world while they're away (off-line). They want to get alerts on special events and crises as well as on scheduled affairs. They want to be able to access the virtual reality on the go, via limited devices. They wish to know where their virtual buddies are and what their availability is. And they want to communicate with their virtual mates using non-virtual conventional devices.

At present, people may utilize the in-game mechanisms which are currently available to them in order to connect their conventional communication means to their virtual worlds. However, these mechanisms are currently extremely limited.

In some virtual environments, designers and vendors provide users with some tools to communicate. These tools can go through and beyond the virtual worlds and penetrate the non-virtual world in a very limited way, if at all. For example, a virtual world known as Second Life™ by Linden Labs allow for images within the game (and only within the game) to text chat, and recently to have textual phone calls inside the game. The only external connection allowed is through email.

There is no simple mechanism allowing a user to connect their virtual reality with their real life reality. Users can't have a phone address book containing real persons side by side with virtual addresses. Nor can they communicate and send messages to virtual friends as they do to their real friends.

In addition, people can communicate with virtual environments using dedicated gaming devices that are designed so as to interface with these virtual environments.

Currently, there is no solution that can provide a converged experience over multiple networks and terminals such as mobile phones—both high end and legacy low end—and at the same time over TV using set top boxes.

There is a growing need to increase the interaction between participants of the virtual environments, as well as enable easier access to the virtual environment.

### SUMMARY OF THE PRESENT INVENTION

In one aspect, a system includes an interface adapted to: receive instructions from a limited device not capable of interfacing with a virtual environment; and send a converted content to the limited device, wherein the converted content is provided by a game emulator; and a game emulator, adapted to convert the instructions to a virtual environment-compliant format; send the converted instructions to a virtual environment computer; receive content from the virtual environment; and convert the content to a limited device-compliant format.

A program product comprising a computer-usable medium including a computer-readable program, wherein the computer-readable program when executed on a computer causes the computer to: receive instructions from a limited device not capable of interfacing with a virtual environment; provide converted instructions by converting a format of the instructions to a virtual-environment compliant format; send the converted instructions to a virtual environment computer; receive content from the virtual environment; generate converted content by converting a format of the content to a limited device-compliant content; and send the converted content to the limited device.

A method for participating in a virtual environment, the method includes: receiving instructions from a limited device not capable of interfacing with the virtual environment; providing converted instructions by converting a format of the instructions to a virtual environment compliant format; sending the converted instructions to a virtual environment computer; receiving content from the virtual environment; generating converted content by converting a format of the content to a limited device-compliant content; and sending the converted content to the limited device.

A system for exchanging information, the system includes: an identity association unit, adapted to store association information that associates between a virtual representation of a recipient and an identity of the recipient; and a gateway, adapted to receive content destined to the virtual representation of the recipient, utilize the association information and send the content to a recipient communication device that is being utilized by the recipient for non-virtual communication; wherein the system is adapted to conceal the association information from the recipient and from the sender.

A program product comprising a computer usable medium including a computer readable program, wherein the computer readable program when executed on a computer causes the computer to: receive content destined to a virtual representation of a recipient; and send the content, by utilizing an association between a virtual representation of the recipient and an identity of the recipient, to a recipient communication device that is being utilized by the recipient for non-virtual communication, while concealing the association.

A method for exchanging information, the method includes: receiving content destined to a virtual representation of a recipient; and sending the content, by utilizing an association between a virtual representation of the recipient and an identity of the recipient, to a recipient communication device that is being utilized by the recipient for non-virtual communication, while concealing the association.

### BRIEF DESCRIPTION OF THE DRAWINGS

The present invention will be understood and appreciated more fully from the following detailed description taken in conjunction with the drawings in which:

FIG. 1 illustrates a system for exchanging information and its environment, according to an embodiment of the invention;

FIG. 2 illustrates a system for exchanging information and its environment, according to an embodiment of the invention;

FIG. 3 illustrates a system for participating in a virtual environment according to an embodiment of the invention;

FIGS. 4-5 are flow charts of methods for exchanging information, according to an embodiment of the invention; and

FIGS. 6-7 are flow charts of methods for participating in a virtual environment according to another embodiment of the invention.

### DETAILED DESCRIPTION OF THE INVENTION

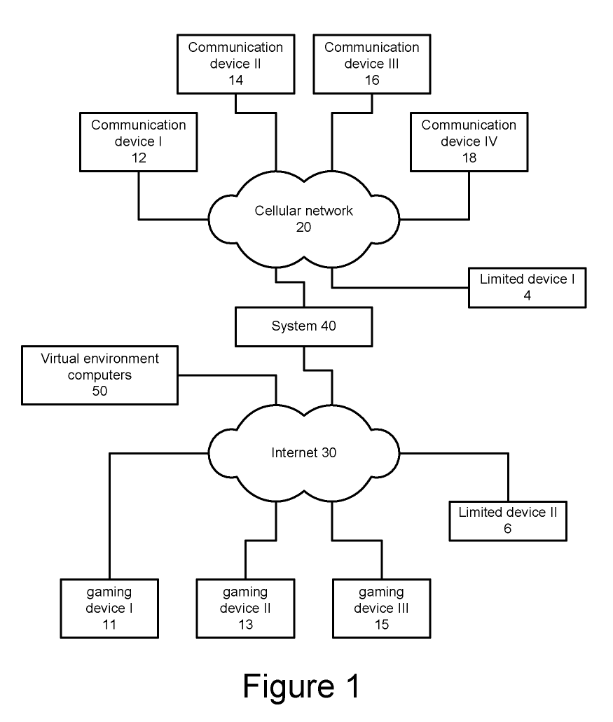

FIG. 1 illustrates a system 40 for exchanging information and its environment, according to an embodiment of the invention.

It is noted that according to an embodiment of the invention system 40 can exchange information between real life persons and avatars, and additionally or alternatively, can enable persons to participate in an environment despite various limitations of the access network, and/or of the devices of these persons.

It is further noted that various protocols and information formats (such as Simple Object Access Protocol (SOAP), Real Time Streaming Protocol (RTSP), Session Initiation Protocol (SIP), Representational State Transfer Protocol (RSTP), Relatively Simple Syndication (RSS), Short Message Peer to Peer protocol (SMPP), Extensible Markup Language (XML) and various multimedia formats such as 3GP, MPEG4 and H264) are mentioned below. It is noted that these protocols are only provided as sample protocols and that the various components and communication devices can communicate by using other protocols.

System 40 is intended to represent any type of computer system capable of carrying out the teachings of the present invention. For example, system 40 could be a server, a cluster of servers, and the like. System 40 can be connected to one or more networks which can be any type of network such as the Internet, a local area network (LAN), a wide area network (WAN), a virtual private network (VPN), etc. In the case of the latter, communication throughout the network could occur via a direct hardwired connection (e.g., serial port), or via an addressable connection that may utilize any combination of wireline and/or wireless transmission methods. Conventional network connectivity, such as Token Ring, Ethernet, WiFi or other conventional communications standards could be used. Still yet, the network can be a fixed, broadband, xDSL or cable Wireless IP, cellular IP (at least second generation), cellular circuit switched network, wireless network (Wifi, WiMax) and the like. For simplicity of explanation, FIG. 1 illustrates one aspect of a system 40 connected to a telecom network 20 and to the Internet 30.

Those of skill in the art will appreciate that a single network can be connected to system 40, that more than two networks can be connected to system 40, that various components of system 40 can be integrated with cellular network components and/or with Internet components.

System 40 can serve multiple communication devices, multiple gaming devices and/or multiple limited devices that are not capable of interfacing with a virtual environment. For simplicity of explanation, only few communication devices, gaming devices and limited devices are shown. It is further noted that a limited device can be a communication device, but this is not necessarily so. Non-limiting examples of limited devices include televisions, set-top boxes (both cable and IP based set-top boxes), tablets, personal digital assistants, cellular devices, game consoles, and the like.

Virtual environment computers 50 can include virtual environment servers, and that each virtual environment server or virtual environment computer can include one or more processors and/or one or more memory units.

Communication devices such as communication devices I-IV 12, 14, 16, 18 are connected via telecom network 20 to system 40. It is noted that the number of communication devices that can be serviced by system 40 can well exceed four and that typically a large number of communication devices can be serviced by system 40. It is noted that a much larger number of communication devices—even hundreds of devices—are expected to be supported by a single server. Each communication device of communication devices 12, 14, 16, 18 is capable of exchanging information over the telecom network 20, such as, but not limited to, a cellular network. Such a communication device can be a mobile phone, a smart phone, a laptop computer, a personal digital assistant, a media player, and the like.

Gaming devices (such as personal computers, game consoles and the like) I-III 11, 13, 15 are connected to system 40 via the Internet 30. These gaming devices 11, 13, 15 can interact with virtual environment computers 50 in order to participate in a virtual environment such as a virtual world. These gaming devices 11, 13, 15 can be used in order to initiate a transfer of content and/or instructions. The content can be eventually delivered to a digital representation of a recipient (if, for example the recipient is on-line), and, additionally or alternatively, can be delivered to a real life communication device of that recipient.

In addition, content sent to the virtual representation of the recipient can be perceived to be received in the virtual environment.

The gaming devices 11, 13, 15 also participate in the reception of such content.

Typically, content can be exchanged between communication devices over telecom network 20, but can also be exchanged between a communication device and a gaming device. In other words, content can be sent from a sender or from a virtual representation of the sender to a recipient or to a virtual representation of the recipient. It is noted that the same content can be sent to both recipient and the virtual representation of the recipient.

Referring to FIG. 1, devices (hereinafter—“limited devices”), such as limited device I 4 and limited device II 6 can be connected to system 40 via the telecom network 20 or via the Internet 30. System 40 allows these devices to interface with virtual environment computers 50 by converting content (instructions, text, and media) and by emulating gaming devices.

In some instances, the limited devices may not have enough computational resources to participate in a virtual environment, but this is not necessarily so. These limited devices can be prevented from participating in virtual environments due to other reasons including, but not limited to, display limitation, protocol and/or information format mismatch, and the like. It is noted that network limitations can also prevent an otherwise non-limited device from participating in the virtual world.

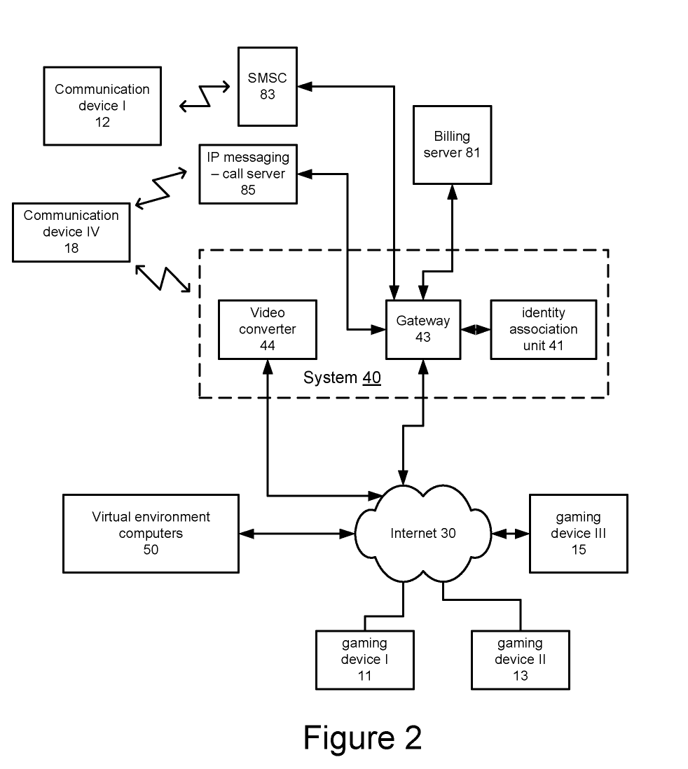

FIG. 2 illustrates system 40 and its environment according to another embodiment of the invention.

FIG. 2 provides a more detailed illustration of system 40 as well as some components of telecom network 20 of FIG. 1. While telecom network 20 is not shown in FIG. 2, some of its components are illustrated. These components include a short message service controller (SMSC) 83, a billing server 81 and an IP messaging-call server 85. All three components 81, 83, 85 are connected to system 40 and specifically to gateway 43. Communication device I 12 can communicate with SMSC 83 by using SMPP protocol. Communication device IV 18 can communicate with IP messaging-call server 85 by using SIP protocol and can communicate with video converter 44 by using 3GP/RTSP protocols. It is noted that SMS is just one service out of a family of IM, Chat, Push to Talk/Show, MMS, VoIP calls (voice and video) and conferencing, voicemail and Multimedia Mail that can be provided by telecom network 20.

System 40 of FIG. 2 includes gateway 43, video converter 44 and identity association unit 41. Gateway 43 is connected (via cellular network that is not shown in this figure) to identity association unit 41 and to Internet 30.

Gateway 43 can communicate with SMSC 83 using the SMPP protocol and can communicate with IP messaging-call server 85 by using RSS protocol, as well as to other servers mentioned above using dozens of other protocols (such as but not limited to XML/HTTP, SOAP, REST, SIP).

Identity association unit 41 is adapted to store association information that associates between a virtual representation of a recipient and an identity of the recipient. Conveniently, identity association unit 41 also stores an association between a virtual representation of a sender and an identity of the sender. The association information is masked, encrypted or otherwise concealed from the recipients and from the receivers.

Especially, the association information is concealed from communication devices I 12 and II 18 and from gaming devices I-III 11, 13, 15. Conveniently, the association information associates between communication related information of the recipient such as his email address, mailing address, and phone number, and between communication-related information of the virtual representation of the recipient such as email address, port number, and the like.

Conveniently, unique cellular phone numbers are allocated to virtual phones of virtual representations of recipients. Once telecom network 20 receives a phone call or message destined to a unique phone number it directs that message or phone call to system 40 that can determine, based upon the association information, how to send that message or how to direct the phone call to the recipient or to its virtual representation.

It is noted that this mapping information can be generated for potential recipients and/or potential senders in advance. A person that wishes to benefit from such an association should undergo a registration process.

Gateway 43 is adapted to receive content destined to the virtual representation of the recipient, utilize the association information and send the content to the recipient communication device that is being utilized by the recipient for non-virtual communication.

Conveniently, identity association unit 41 also stores information relating to senders and their virtual representation. According to an embodiment of the invention system 40 can send to the recipient communication device information relating to a virtual representation of the sender. Thus, a name, an image (a video clip, a sound, an animated GIF and alike) and/or a virtual phone number of the virtual representation of the sender can be displayed to the recipient.

Gateway 43 can receive content and decide whether to provide the content to the recipient communication device or to virtually provide the content to the virtual representation of the recipient. The determination can be responsive to one or more rules that can be responsive to the status of the virtual representation of the recipient (especially if the recipient is off line or has ceased to interact with the virtual environment), to the identity of the sender, to the identity of the recipient, to the time of content reception (for example—if the content is received in the middle of the night), to a capability of the virtual representation of the recipient to store the content (for example—if a predefined storage threshold has been exceeded), and the like. If, for example, the virtual representation of the recipient is involved in certain virtual activities (such as conducting another virtual call, participating in a game or in an otherwise resource consuming activity) then the content can be sent to the recipient, but this is not necessarily so. For example, the content can be kept in the server until the user is free again. It is noted that the determination can be responsive to temporal load on the virtual environment computers, to temporal load on the cellular network, to presence information of the recipient in the real world, and the like.

According to yet a further embodiment of the invention, system 40 can temporarily delay the provision of the content. The length of the delay can be determined in advance.

Yet according to another embodiment of the invention content can be stored for later retrieval. This can enable a recovery of the transmitted content if (for example) a communication failure occurred.

Conveniently, the content is sent either to the recipient or to its virtual representation, or in one aspect, the content can be sent to both. The content can be sent to the virtual representation of the recipient while a link or an alert is sent to the recipient, or vice versa. The alert or link can simplify or otherwise ease the retrieval of the content.

Referring to FIG. 2, gateway 43 can receive content from a sender communication device (such as communication device I 12 and/or communication device IV 18) that is being utilized by the sender for non-virtual communications. Additionally or alternatively, gateway 43 can receive the content from virtual communication computers 50. In other words, the content can be provided from a sender (former case) or from a virtual representation of the sender (latter case).

Video converter 44 can convert a format of video sent from virtual environment computers 50 to a sender's communication device format, if such a conversion is necessary. For example, it can receive a video stream that is streamed from virtual environment computers 50, convert the video to a compatible format, and send the converted video to communication device IV 18 using 3GP and/or RTSP protocols. It is noted that other digital video formats and codecs such as H.264, H.263 can be used.

It is noted that a communication device that is being used for non-virtual communication can also be used for virtual communication. Such a communication device can be a mobile phone, a smart phone, a personal digital assistant, a computer that facilitates phone calls, a video conferencing device, and the like.

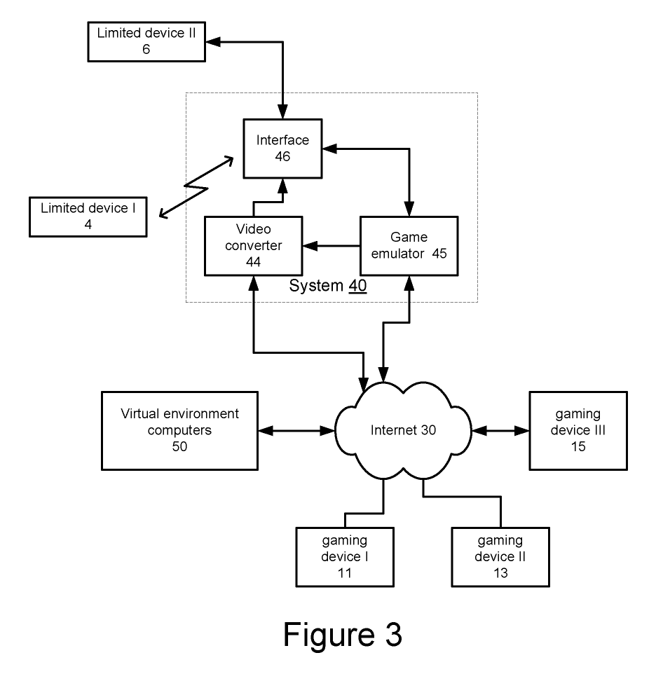

FIG. 3 illustrates system 40 and its environment according to an embodiment of the invention.

FIG. 3 provides a more detailed illustration of one aspect of system 40 as well as of some components of telecom network 20 of FIG. 1. While telecom network 20 is not shown in FIG. 3, interface 46, which can belong to a cellular network, is shown.

Limited device I 4 and limited device II 6 can communicate with interface 46 using RTSP, SIP and/or SOAP protocols. Conveniently, the instructions sent by these limited devices to interface 46 are XML-formatted instructions.

System 40 of FIG. 3 includes interface 46, video converter 44 and game emulator 45. Interface 46 is connected to video converter 44 and game emulator 45. Game emulator 45 is also connected to video converter 44 and to virtual environment computers 50 (via internet 30). Game emulator 45 can send video converter 44 raw video. Video converter 44 can send interface 46 MPEG4 or H264 compliant video. Interface 46 and game emulator 45 can communicate by using SOAP/REST or other signaling protocols.

Conveniently, interface 46 is adapted to receive instructions from a limited device not capable of interfacing with the virtual environment, and is also adapted to send converted content provided by game emulator 45 to the limited device.

Game emulator 45 can bridge the gap between the limited devices and the virtual environment computers 50. Game emulator 45 is adapted to: (i) convert a format of the instructions to virtual environment-compliant format; (ii) send the converted instructions to a virtual environment computer 50; (iii) receive content from the virtual environment; (iv) generate converted content by converting a format of the content to a limited device-compliant content and (v) send the converted content to the limited devices.

Game emulator can also receive content other than instructions from a limited device. It can then perform the required conversions and send the converted content to the virtual environment computers 50. Such content can include text to be associated with the virtual representation of the user; text messages to be displayed in the virtual environment; voice; sound; photo; video; and the like. For simplicity of explanation the following description relates to instructions.

The instruction can affect the virtual environment. The content sent to system 40 and the converted content produced by system 40 can reflect this affect. The virtual environment can be affected due to movements or other actions performed by a virtual representation of the user of the limited device, but this is not always the case.

Conveniently, the limited device may or may not host a thin client that does not consume many resources and is capable of converting user actions (such as pressing a button, touching a touch screen, moving a mouse or joystick, and the like) to game emulator instructions, and can also receive content sent from interface 46 and assist in the display and/or sounding of converted content received from interface 46. Without a client, other mechanisms for control will be applied (e.g. DTMF in the case of gaming over 3G circuit switch, or browser-based widgets in the case of IP connection).

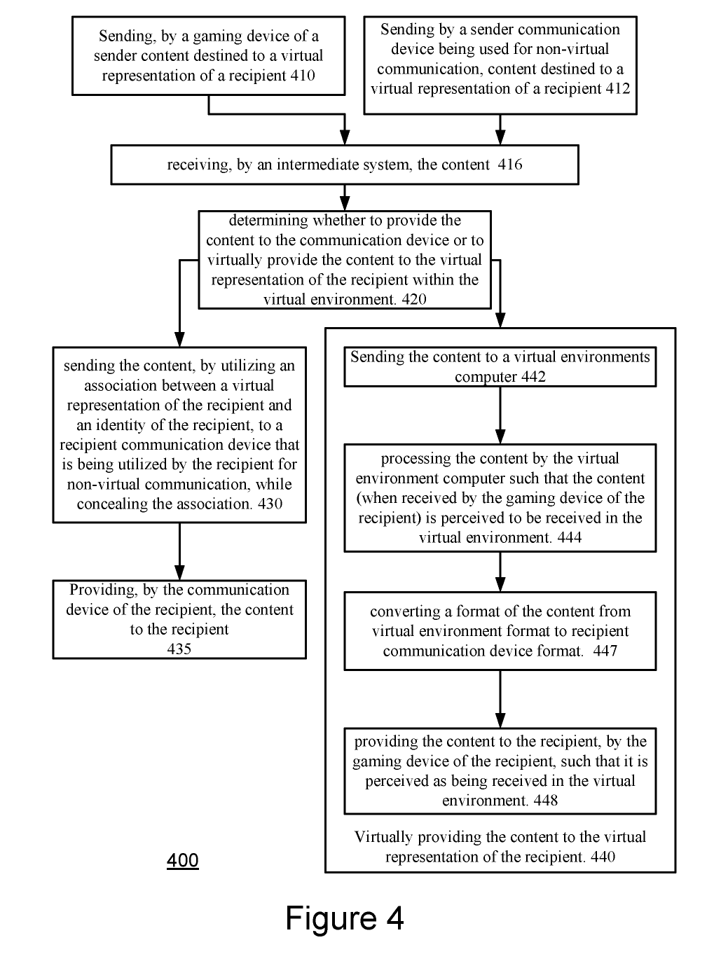

FIG. 4 illustrates method 400 for exchanging information according to an embodiment of the invention.

Method 400 starts by stage 410 or 412. Both stages are followed by stage 416.

Stage 410 includes sending, by a gaming device of a sender, content destined for a virtual representation of a recipient.

Stage 412 includes sending, by a sender communication device being user for non-virtual communication, content destined to a virtual representation of a recipient.

Stage 416 includes receiving, by an intermediate system, the content. Referring to the example set forth in FIGS. 1 and 2, the intermediate system is system 40, the gaming devices include gaming devices I-III 11, 13, 15, and the sender communication devices can includes communication devices I-IV 12, 14, 16, 18.

Stage 416 is followed by stage 420, of determining whether to provide the content to the recipient communication device or to virtually provide the content to the virtual representation of the recipient. Referring to the example set forth in FIGS. 1 and 2, the virtually providing the content includes sending the content to a gaming device such that the content is perceived as being received in the virtual environment supported by virtual environment computers 50. It is noted that this process may involve sending the content to virtual environment computers 50 that can alter the virtual environment such that the content appears in the virtual environment.

The determining decision of stage 420 can be responsive to one or more rules that can be responsive to: the status of the virtual representation of the recipient (especially if the recipient is off line or has ceased to interact with the virtual environment); the identity of the sender; the identity of the recipient; the time of content reception (for example, if the content is received in the middle of the night); a capability of the virtual representation of the recipient to store the content (for example, if a predefined storage threshold has been exceeded); and the like. If, for example, the virtual representation of the recipient is involved in a virtual activity (such as conducting another virtual call, participating in a virtual game or an otherwise resource-consuming activity), then the content can be sent to the recipient; although this is not always the case. The determination decision 420 can be responsive to temporal load on the virtual environment computers 50, on the cellular (or other) network connecting the terminal, and the like.

According to yet a further embodiment of the invention stage 420 can be followed by both stages 430 and 440.

If the content should be provided to the recipient communication device, then stage 420 is followed by stage 430 of sending the content, by utilizing an association between a virtual representation of the recipient and an identity of the recipient, to a recipient communication device that is being utilized by the recipient for non-virtual communication, while concealing the association. Stage 430 is followed by providing (for example by displaying) the content to the recipient using the recipient's communication device.

If the content should be virtually provided to the virtual representation of the recipient, then stage 420 is followed by stage 440 of virtually providing the content to the virtual representation of the recipient.

Stage 440 includes the following stages: (i) stage 442 of providing the content to a virtual environment computer, (ii) stage 444 of processing the content by the virtual environment computer such that the content (when received by the gaming device of the recipient) is perceived to be received in the virtual environment, (iii) stage 447 of converting a format of the content from virtual environment format to recipient communication device format, and (iv) stage 448 of providing the content to the recipient such that it is perceived as being received in the virtual environment.

Conveniently, stage 420 includes concealing communication-related information required for non-virtual communication with the recipient communication device.

Conveniently, stage 430 includes sending to the recipient communication device information relating to a virtual representation of the sender.

It is further noted that method 400 can include storing the content, delaying a provision of the content and/or of the converted content, and the like.

It is further noted that method 400 can include sending content to a virtual representation of the recipient while a link or an alert is sent to the recipient, or vice versa. The alert or link can simplify or otherwise ease the retrieval of the content.

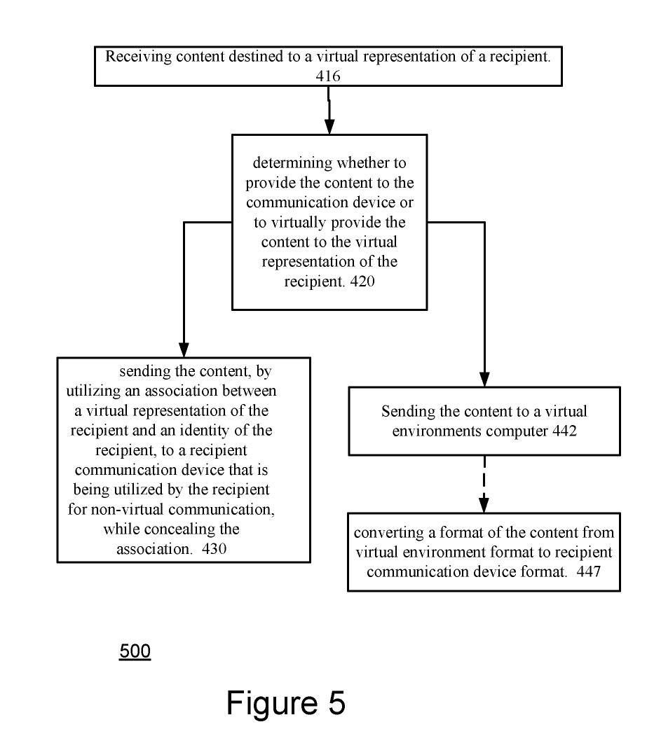

FIG. 5 illustrates a method 500 for exchanging information, according to an embodiment of the invention.

Method 500 differs from method 400 by not including stages executed by components other than an intermediate system such as system 40. Accordingly, method 500 includes stages 416, 420, 430, 442 and 447 and does not include stages 410, 412, 435, 444, 446 and 448. In other words, method 500 does not include stages that are executed by entities such as a gaming device of a user, a sender communication device, virtual environment computers, an intermediate system and the like.

Method 500 starts with stage 416. Stage 416 is followed by stage 420. Stage 420 is followed by either stages 430 and 442. Stage 442 is followed by stage 447.

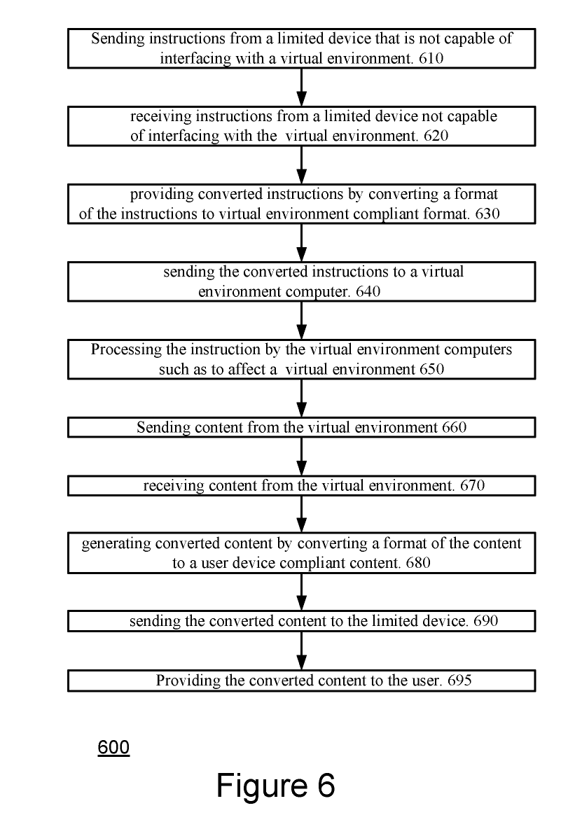

FIG. 6 illustrates a method 600 for participating in a virtual environment, according to another embodiment of the invention.

Method 600 starts by stage 610 of sending instructions to the system from a limited device that is not capable of interfacing with a virtual environment.

Stage 610 is followed by stage 620, of the system receiving the instructions from the limited device not capable of interfacing with the virtual environment. Referring to the example set forth in FIGS. 1 and 3, an intermediate system such as system 40 receives instructions from limited device I 4 or from limited device II 6.

In one aspect, stage 620 includes receiving instructions from a thin client hosted by the limited device. The thin client is characterized by relatively low resource consumption.

Stage 620 is followed by stage 630 of converting a format of the instructions to a virtual environment compliant format.

In one aspect, stage 630 includes converting extensible markup language (XML) instructions.

Stage 630 is followed by stage 640, of sending the converted instructions to a virtual environment computer.

Stage 640 is followed by stage 650 of processing the instruction, using the virtual environment computer, such as to affect a virtual environment.

Stage 650 can be followed by stage 660 of sending content from the virtual environment to the system. It is noted that stage 660 can occur regardless of the timing of stages 610-650. If stage 650 is followed by stage 660 then the content can represent a change in the environment that resulted from the processing of the instruction.

Stage 660 is followed by stage 670 of the system receiving the content from the virtual environment.

Stage 670 is followed by stage 680 of converting a format of the content to a limited device-compliant format.

Stage 680 is followed by stage 690 of sending the converted content to the limited device.

Stage 690 is followed by stage 695 of providing the converted content to the user on the limited device.

Stage 680 may also include generating a media stream representative of the virtual environment component affected by the instructions.

Stage 680 may further include trans-coding a media stream formatted in a virtual environment format. The trans-coding includes changing the format of the data to another, to match the target device. It involves a direct digital-to-digital conversion from one codec to another. In this invention, we change the graphics of the game to JPEG or to MPEG4 which is more standard format in phones.

In one aspect, stages 630 and 680 are executed by a game emulator that has a processing capability that exceeds a processing capability of the limited device.

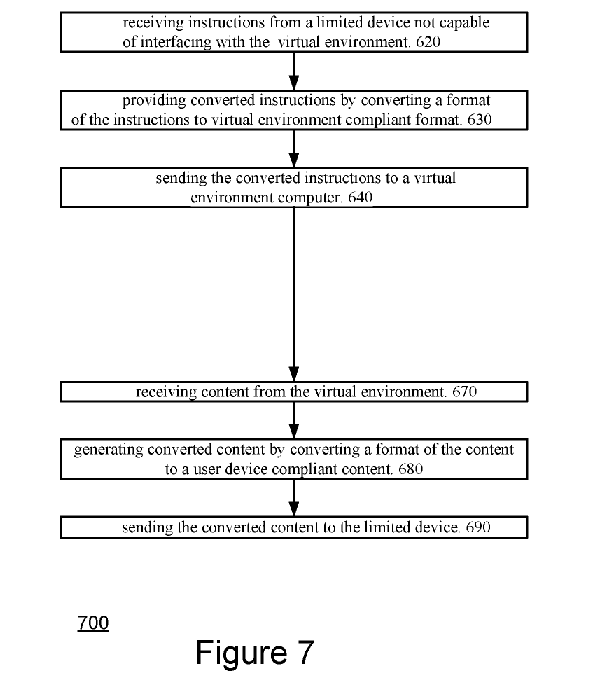

FIG. 7 illustrates method 700 for exchanging information, according to an embodiment of the invention.

Method 700 differs from method 600 by not including stages executed by components other than an intermediate system such as system 40. Accordingly, method 700 includes stages 620, 630, 640, 670, 680 and 690 and does not include stages 610, 650, 660 and 695.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies regardless of the particular type of signal-bearing media actually used to carry out the distribution. Examples of computer readable media include recordable-type media such as a floppy disk, a hard disk drive, a RAM, and CD-ROMs. Other types of signal-bearing media are transmission-type media such as digital and analog communication links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

Accordingly, the invention is to be defined not by the preceding illustrative description but instead by the spirit and scope of the following claims.

What is claimed is:

1. A method for exchanging information, the method comprising:
receiving content destined to a virtual representation of a recipient; and
sending the content to a recipient communication device that is being utilized by the recipient for non-virtual communication by utilizing an association between a virtual representation of the recipient and an identity of the recipient while concealing the association.

2. The method according to claim 1 wherein the concealing comprises concealing communication-related information required for non-virtual communication with the recipient communication device.

3. The method according to claim 1 wherein the sending comprises sending to the recipient communication device information relating to a virtual representation of the sender.

4. The method according to claim 1 further comprising determining whether to provide the content to the recipient communication device or to virtually provide the content to the virtual representation of the recipient.

5. The method according to claim 4 wherein the determining is responsive to a status of the virtual representation of the recipient.

6. The method according to claim 1 wherein the sending comprises sending the content to the recipient communication device when the recipient does not interact with the virtual environment.

7. The method according to claim 1 wherein the receiving comprises receiving the content from a sender communication device that is being utilized by the sender for non-virtual communications.

8. The method according to claim 1 wherein the receiving comprises receiving the content from a virtual environment computer.

9. The method according to claim 1 wherein the sending is preceded by converting a format of the content from a virtual environment format to a recipient communication device content format.

10. A program product comprising a computer usable medium including a computer readable program, wherein the computer readable program when executed on a computer causes the computer to:
receive content destined to a virtual representation of a recipient; and
send the content to a recipient communication device that is being utilized by the recipient for non-virtual communication by utilizing an association between a virtual representation of the recipient and an identity of the recipient while concealing the association.

11. The program product according to claim 10, wherein the computer readable program when executed on a computer causes the computer to conceal communication-related information required for non-virtual communication with the recipient communication device.

12. The program product according to claim 10, wherein the computer readable program, when executed on a computer, causes the computer to send to the recipient communication device information relating to a virtual representation of the sender.

13. The program product according to claim 10, wherein the computer readable program, when executed on a computer, causes the computer to determine whether to provide the content to the recipient communication device or to virtually provide the content to the virtual representation of the recipient.

14. The program product according to claim 13, wherein the computer readable program when executed on a computer causes the computer to determine, in response to a status of the virtual representation of the recipient, whether to provide the content to the recipient communication device or to virtually provide the content to the virtual representation of the recipient.

15. The program product according to claim 10, wherein the computer readable program, when executed on a computer, causes the computer to send the content to the recipient communication device when the recipient does not interact with the virtual environment.

16. The program product according to claim 10, wherein the computer readable program when executed on a computer causes the computer to receive the content from a sender communication device that is being utilized by the sender for non-virtual communications.

17. The program product according to claim 10, wherein the computer readable program when executed on a computer causes the computer to receive the content from a virtual environment computer.

18. The program product according to claim 10, wherein the computer readable program when executed on a computer causes the computer to convert a format of the content from a virtual environment format to a recipient communication device format.

19. A system for exchanging information, the system comprising:
an identity association unit, adapted to store association information that associates a virtual representation of a recipient with an identity of the recipient; and
a gateway, adapted to receive content destined for the virtual representation of the recipient, and utilize the association information to send the content to a recipient communication device that is being utilized by the recipient for non-virtual communication; wherein the system is adapted to conceal the association information from the recipient and from the sender.

20. The system according to claim 19 wherein the identity association unit is adapted to conceal communication related information required for non-virtual communication with the recipient communication device.

21. The system according to claim 19 further adapted to send to the recipient communication device information relating to a virtual representation of the sender.

22. The system according to claim 19 further adapted to determine whether to provide the content to the recipient communication device or to virtually provide the content to the virtual representation of the recipient.

23. The system according to claim 22 wherein the system is adapted to determine in response to a status of the virtual representation of the recipient whether to provide the content to the recipient device or to virtually provide the content to the virtual representation of the recipient.

24. The system according to claim 22 further adapted to send the content to the communication device when the recipient is not interacting with the virtual environment.

25. The system according to claim 19 wherein the gateway is adapted to receive the content from a sender communication device that is being utilized by the sender for non-virtual communications.

26. The system according to claim 19 wherein the gateway is adapted to receive the content from a virtual environment computer.

27. A method for participating in a virtual environment, the method comprising:
receiving instructions from a limited device not capable of interfacing with the virtual environment;
converting the instructions to a virtual environment-compliant format;
sending the converted instructions to a virtual environment computer;
receiving content from the virtual environment;
converting the content to a user device-compliant content; and
sending the converted content to the limited device.

28. The method according to claim 27 wherein converting the content to a limited device-compliant content comprises generating a media stream representative of virtual environment component affected by the instructions.

29. The method according to claim 27 wherein converting the content to a limited device-compliant content comprises trans-coding a media stream formatted in a virtual environment format.

30. The method according to claim 27 wherein the providing and generating are executed by a game emulator that has a processing capability that exceeds a processing capability of the limited device.

31. The method according to claim 27 wherein the stage of receiving instructions comprises receiving instructions from a thin client hosted by the limited device.

32. The method according to claim 27 wherein the stage of providing comprises converting extensible markup language instructions.

33. A program product comprising a computer usable medium including a computer-readable program, wherein the computer-readable program, when executed on a computer, causes the computer to: receive instructions from a limited device not capable of interfacing with the virtual environment; converting the instructions to virtual environment compliant format; send the converted instructions to a virtual environment computer; receive content from the virtual environment; converting the content to a user device-compliant content; and send the converted content to the limited device.

34. The program product according to claim 33, wherein the computer readable program when executed on a computer causes the computer to generate a media stream representative of a virtual environment component affected by the instructions.

35. The program product according to claim 33, wherein the computer readable program when executed on a computer causes the computer to trans-code a media stream formatted in a virtual environment format.

36. The program product according to claim 33, wherein the computer readable program when executed on a computer causes the computer to receive instructions from a thin client hosted by the limited device.

37. The program product according to claim 33, wherein the computer-readable program when executed on a computer causes the computer to convert extensible markup language (XML) instructions.

38. A system, comprising:
an interface, adapted to:
receive instructions from a limited device not capable of interfacing with the virtual environment; and
send converted content to the limited device; and
a game emulator, adapted to:
convert the instructions to a virtual environment-compliant format;
send the converted instructions to a virtual environment computer;
receive content from the virtual environment; and
convert the content to a limited device compliant content.

39. The system according to claim 38, wherein the system is adapted to generate a media stream representative of a virtual environment component affected by the instructions.

40. The system according to claim 38, wherein the system is adapted to trans-code a media stream formatted in a virtual environment format.

41. The system according to claim 38, wherein the system is adapted to receive instructions from a thin client hosted by the limited device.

42. The system according to claim 38, wherein the system is adapted to convert extensible markup language (XML) instructions.
